(19) United States
(12) Patent Application Publication
(10) Pub. No.: US 2006/0111054 A1
(43) Pub. Date: May 25, 2006

(54) Method and system for selecting transmit antennas to reduce antenna correlation

(75) Inventors: Jung-Lin Pan, Selden, NY (US); Yingming Tsai, Boonton, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/042,411

(22) Filed: Jan. 25, 2005

Related U.S. Application Data
(60) Provisional application No. 60/629,963, filed on Nov. 22, 2004.

(51) Int. Cl. H04B 7/02

(52) U.S. Cl. 455/101; 455/97

(57) ABSTRACT

A method and system is disclosed for transmitting data over at least one transmit antenna to reduce antenna correlation in wireless communication systems. The transmit antennas are comprised of randomly selected antenna elements wherein the antenna elements are randomly selected from antenna elements of a plurality of antennas of a node in a wireless communication system. The number of antenna elements in a group of randomly selected antenna elements may be fixed or may vary over time.

### CROSS REFERENCE TO RELATED APPLICATION(S)

This application claims the benefit of U.S. Patent Application No. 60/629,963, filed Nov. 22, 2004 which is incorporated by reference as if fully set forth.

### FIELD OF INVENTION

The present invention is related to wireless communication systems. More particularly, the present invention is related to a method and system for selecting transmit antennas to reduce antenna correlation.

### BACKGROUND

Multiple-input multiple-output (MIMO) refers to a type of wireless transmission and reception scheme where both the transmitter and receiver employ more than one antenna. Special cases of MIMO are when there is a single antenna on the receiver side and multiple antennas on the transmit side, called single-input multiple-output (SIMO), and when there are multiple antennas on the receiver side and one antenna on the transmitter side, called multiple-input single-output (MISO), and a traditional transmission scheme with one antenna on both sides is a Single-Input Single-Output (SISO).

A MIMO system takes advantage of the spatial diversity or spatial multiplexing options created by the presence of multiple antennas and improves signal to noise ratio and increases throughput. It has been seen in the past that multipath (once a big hurdle in wireless communications) can help improve the overall performance if it is processed properly by the transmitter and the receiver. Essentially, each multipath component carries information about the transmitted signal, therefore if the multipath components are resolved and collected appropriately they should reveal more information about the transmitted signal.

An antenna correlation is one of the factors causing diversity reduction and capacity decrease of multiple antenna systems, such as multiple-input/multiple-output (MIMO) systems, in wireless communication. Antenna correlation is a correlation measurement between the different signal propagation paths of the transmit and receive antennas. For an antenna system having N transmit antennas and M receiving antennas, a correlation matrix of dimension M by N is usually used to describe the antenna correlation between transmit and receive antennas.

A conventional MIMO system selects particular transmit antennas for transmission which enhances performance. The conventional MIMO system requires antenna feedback information to perform the selection of transmit antennas. The most common feedback information is the channel impulse response. Usually the feedback information comes from the receiver wherein the receiver estimates the channel impulse responses and sends them back to the transmitter for processing. The process for obtaining the feedback information is usually complex and is not easy to implement.

Therefore, it would be desirable to provide a method and system wherein antenna selection may be accomplished with little or no feedback information provided to a transmitter.

### SUMMARY

The present invention is a method and system for transmitting data over at least one transmit antenna to reduce antenna correlation in wireless communication systems. The transmit antennas are comprised of randomly selected antenna elements wherein the antenna elements are randomly selected from antenna elements of a plurality of antennas of a node in a wireless communication system. The number of antenna elements in a group of randomly selected antenna elements may be fixed or may vary over time.

### BRIEF DESCRIPTION OF THE DRAWINGS

FIG. 1 shows a system for implementing transmit antenna selection to reduce antenna correlation in accordance with the present invention.

FIG. 2 is a block diagram of a transmitter configured to perform transmit antenna selection in accordance with the present invention.

### DETAILED DESCRIPTION OF THE PREFERRED EMBODIMENTS

The present invention provides a transmit antenna selection (i.e. antenna hopping) technique that effectively reduces antenna correlations at a transmit antenna and a receive antenna, thereby providing increased diversity and enhanced capacity in a wireless communication system. The antenna hopping technique of the present invention does not require any feedback information. Therefore, a system in accordance with the present invention is less complicated, easy to implement, and increases system capacity by reducing antenna correlation.

The present invention is applicable to any type of wireless communication system including, but not limited to, cellular systems, mobile systems, wireless LANS, MANS, and PANS, fixed access systems, and ad-hoc/mesh networks. Examples of such wireless communication systems include 1G through 3G cellular systems (AMPS, IS-136, GSM/GPRS/EDGE, IS-95, CDMA2000, UMTS FDD/TDD) and the 802.xx family (802.11, 802.16, 802.15).

Herein, a wireless transmit/receive unit (WTRU) includes but is not limited to a user equipment, mobile station, fixed or mobile subscriber unit, pager, or any other type of device capable of operating in a wireless environment. When referred to herein, a base station includes but is not limited to a Node-B, site controller, access point (AP) or any other type of interfacing device in a wireless environment. For convenience in describing the present invention, a base station is a “transmitting terminal,” however, any node capable of transmitting communication signals may be the transmitting terminal. Similarly, for convenience in describing the present invention, a WTRU is a “receiving terminal,” however any node capable of receiving communication signals may be the receiving terminal.

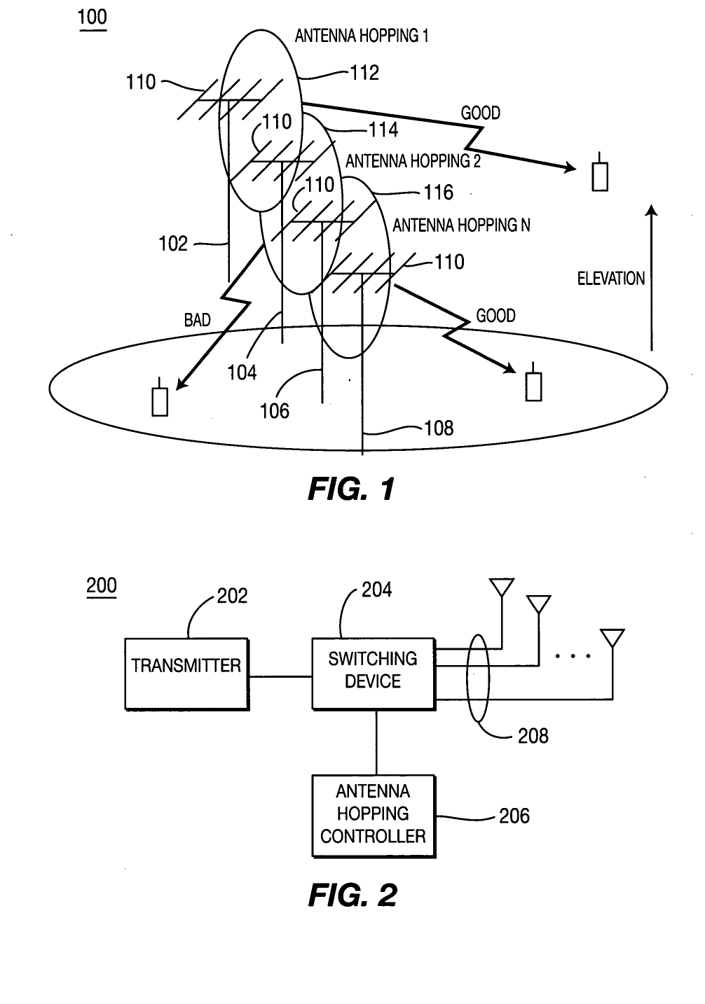

FIG. 1 is a diagram of a wireless communication system 100 in accordance with the present invention. The system 100 includes a plurality of antennas 102, 104, 106, 108 that make up an antenna array of a single wireless entity which, in this case, is a base station (not shown). Each antenna 102, 104, 106, 108 includes a plurality of antenna elements 110. In a preferred embodiment of the present invention, various antenna elements 110 from each antenna 102, 104, 106, 108 may be grouped virtually where each virtual grouping of antenna elements effectively function as a single transmit antenna (i.e. a virtual transmit antenna having elements spanning any number of physical antennas). By way of example, in FIG. 1, three transmit antennas are shown 112, 114, 116.

The antenna elements 110 are preferably selected “randomly” according to a pseudo-random number generator or based on some predetermined randomized random, pseudorandom or other non-random predetermined pattern sequence. While a true random selection is possible, the random selection according to the present invention can be effected with pseudo-random selection. This produces a random effect as used in the invention. As used herein, “random” and “random selection” includes pseudo-random and pseudo-random selection.

Each time a randomized set of antenna elements are selected, data is transmitted over that particular randomized set of antenna elements, wherein the randomized set of antenna elements effectively operate as a single transmit antenna. This results in the data being transmitted in a similar randomized fashion over the entire set of antenna elements according to the randomized selection, which is considered to be a form of antenna hopping. Data transmissions follow the antenna hopping patterns. Random selection has the advantage of not requiring feedback information from a receiver and simplifies the systems as compared to pre-selection methods.

At any given point in time, each group of antenna elements 110 will have a particular degree of correlation. Thus, one group of antenna elements 110 may experience high correlation, for example transmit antenna 114, while certain combinations of antennas do not, for example transmit antennas 112 and 116. Ideally, one would use the transmit antennas 112, 116 having low correlation for data transmission at any given time. It has been found, however, that such arrangements are often difficult or expensive to implement and sometimes are not even feasible. Therefore, pursuant to a preferred embodiment of the present invention, random selection of antennas or antenna hopping can achieve a similar goal, but with reduced complexity.

For example, in the present invention, even though at any time a “bad” combination of antenna elements (i.e. a combination of antenna elements having high correlation) may occur, because of randomness, the frequency of such “bad” combination is at a low level. Therefore, despite the possibility of a “bad” combination, in the long run, the overall performance of the antenna system is enhanced and antenna diversity is increased with reduced system complexity.

It is noted that antenna hopping in accordance with the present invention can artificially create fast fading conditions from slow fading. This is beneficial, for example, when wireless users are in deep and slow fading for certain antenna transmission and reception. By using antenna hopping, the deep and slow fading conditions can be alleviated and burst error can be avoided. The antenna diversity can be achieved in both azimuth and elevation directions. In fast fading the “bad” signal can become a “good” signal in a short period of time, while in slow fading the “bad” signal will remain “bad” for a long period of time before it becomes a “good” signal. By randomly hopping the signal around transmit antennas, it creates the fast fading scenario.

It should be clear that it is possible to provide configurations in which each transmit antenna 112, 114, 116 is substantially identical in size or other aspects of configuration. It is also possible to perform other configuration changes such as arranging dipoles in opposite polarities or arranging elements singularly or in pairs of elements which are not in alignment.

In each arrangement, the size of a transmit antenna is defined in the context of the present invention as the number of antenna elements making up a particular transmit antenna. In accordance with a first embodiment of the invention, the size of antennas is selected randomly each time, and then the antennas are randomly selected according to the selected size. Antenna size can be pre-configured or dynamically configured during the run time. Likewise, the antenna configuration can be dynamically changed or pre-configured. For example, the antenna size is selected randomly each time the system decides to change antenna size to optimize performance or for other reasons.

This approach uses a dynamically configurable method which can allow the antenna size to be changed during the run time. For example, M1 antenna elements are selected from among 1, 2, . . . , M_{T} antenna elements. In this case, there are C_{M}_{¹}^{M}^{_{T}} possible combinations for selecting M1 antenna elements from M_{T} antenna elements. Next time the antenna size is adjusted, the antenna size is again selected randomly from 1, 2, . . . , M_{T}, say M2, and then, M2 antennas are selected randomly from among M_{T} antennas. In this case, there are C_{M}_{²}^{M}^{_{T}} possible combinations.

In accordance with a second embodiment, the size of antennas is fixed and the antennas are randomly selected according to the fixed size. For example, assume antenna size is fixed and predetermined at say, M. In this case, M antenna elements are selected randomly among M_{T} antenna elements each time the system decides to change antenna size to optimize performance or for other reasons. The selected antennas belong to one of the C_{M}^{M}^{_{T}} possible combinations.

By determining the size of the transmit antennas as explained above, the correlation between antennas is reduced because the signal hops around the selected antenna elements based on the pre-determined antenna size thereby avoiding the bad antenna combinations (i.e. those with high antenna correlation) over time. It is noted that the antenna hopping technique in accordance with the present invention is applicable to both 2-D wireless systems with azimuth as a parameter and 3-D wireless systems with both azimuth and elevation as parameters. For 2-D wireless systems, the correlation reduction occurs in azimuth. For 3-D wireless systems, the reduction in correlation may occur in both azimuth and elevation.

Referring now to FIG. 2, there is shown an antenna hopping transmitter 200. The antenna hopping transmitter 200 includes a transmitter 202, a switching device 204, an antenna hopping controller 206, and a plurality of antennas 208. As explained above, each antenna 208 includes a plurality of antenna elements (not shown). The transmitter 202 outputs a data signal to the switching device 204. The switching device 204 transmits the signal over a randomly selected group of antenna elements to increase the diversity with which the signal is being transmitted. The antenna elements are randomly selected from the antenna elements of the antennas 208 according to a random selection generated by the antenna hopping controller 206. The randomly selected antenna elements preferably vary over time. Further, the number of elements selected as part of a randomly selected group of antenna elements may be fixed or may be dynamically adjusted according to a particular algorithm.

Although feed-back information is not required when implementing the teachings of the present invention, it may be utilized in alternate embodiments. Therefore, in a preferred embodiment, signals received at a receiver are processed by the receiver to determine signal quality, antenna correlations, and other related measurements for each transmit antenna at the transmitter. Preferably, identification numbers are sent back identifying the transmit antennas from which signals are being received with satisfactory measurements. The feedback of antenna identification numbers simplifies the system and results in less data being sent back to the transmitter for processing. For example, in the present invention, transmit antenna identification numbers may be 1, 2, 3, . . . N depending on the number of active transmit antennas (i.e. those actually transmitting data) and the maximum number of antennas at the transmit site, say N. For a transmit site having eight antennas, the feedback information consists of only three binary numbers. This is much less complicated than processing of channel impulse responses as in currently known systems. In currently known systems, assuming there are L paths for channel impulse response per antenna, feedback information may require L complex numbers for each antenna. For example, there will be N times L complex numbers to be feedback to the transmitter and each complex number requires two floating numbers wherein each floating number may require some amount of binary numbers, say Q, to be represented. This arrangement results in significantly more processing being performed at the transmit site in order to process the feedback information.

It is noted that additional information may be provided along with the identification numbers. For example, information such as channel state, antenna correlation, signal quality, etc. may be feedback along with the identification numbers.

Although the elements in the Figures are illustrated as separate elements, these elements may be implemented on a single integrated circuit (IC), such as an application specific integrated circuit (ASIC), multiple ICs, discrete components, or a combination of discrete components and IC(s).

Although the features and elements of the present invention are described in the preferred embodiments in particular combinations, each feature or element can be used alone without the other features and elements of the preferred embodiments or in various combinations with or without other features and elements of the present invention. Furthermore, the present invention may be implemented in any type of wireless communication system.

What is claimed is:

1. In a wireless communication system, a method of selecting antennas to transmit data, the method comprising:
establishing an antenna size for a virtual transmit antenna wherein antenna size is defined as a number of antenna elements making up the virtual transmit antenna; and
selecting antenna elements from an antenna array to create the virtual transmit antenna wherein the number of antenna elements selected is equal to the antenna size of the virtual transmit antenna and less than an array antenna size of the antenna array.

2. The method of claim 1 comprising providing the antenna size as a fixed size.

3. The method of claim 2 comprising:
changing the selected antenna elements making up the virtual transmit antenna by re-establishing antennas from which the antenna elements were selected; and
performing an antenna hopping sequence, the antenna hopping sequence extending across the antenna array.

4. The method of claim 3 wherein said antenna hopping sequence provides antenna diversity in an azimuth direction while maintaining a substantially constant elevation direction.

5. The method of claim 3 wherein said antenna hopping sequence provides antenna diversity in both azimuth and elevation directions.

6. The method of claim 1 further comprising establishing antennas from an antenna array including establishing antenna size, such that a configuration of the antennas established from an antenna array establishes the antenna size.

7. The method of claim 6 comprising:
changing the antenna configuration by re-establishing the antennas; and
performing an antenna hopping sequence, the antenna hopping sequence extending across plural antenna configurations of the same antenna array.

8. The method of claim 7 comprising maintaining a substantially constant antenna size across plural antenna hops in the antenna hopping sequence.

9. The method of claim 6 wherein said antenna hopping sequence provides antenna diversity in an azimuth direction while maintaining a substantially constant elevation direction.

10. The method of claim 6 wherein said antenna hopping sequence provides antenna diversity in both azimuth and elevation directions.

11. A multiple in/multiple out (MIMO) wireless communication system comprising:
a circuit configured to establish an antenna size for a virtual transmit antenna wherein antenna size is defined as a number of antenna elements making up the virtual transmit antenna; and
a circuit configured to randomly select antenna elements from an antenna array to create the virtual transmit antenna wherein the number of antenna elements selected is equal to the antenna size of the virtual transmit antenna and less than an array antenna size of the antenna array.

12. The MIMO communication system of claim 11 wherein the circuit configured to randomly select antenna elements is further configured to provide a fixed antenna size.

13. The MIMO communication system of claim 12 comprising:
the circuit configured to randomly select antenna elements making up the virtual transmit antenna by re-establishing antennas from which the antenna elements were selected; and
a circuit configured to perform an antenna hopping sequence, the antenna hopping sequence extending across the antenna elements.

14. The MIMO communication system of claim 13 wherein said circuit for performing an antenna hopping sequence provides antenna diversity in an azimuth direction while maintaining a substantially constant elevation direction.

15. The MIMO communication system of claim 13 wherein said circuit for performing an antenna hopping sequence provides antenna diversity in both azimuth and elevation directions.

16. The MIMO communication system of claim 11 wherein the circuit configured to randomly selected antenna elements is further configured to establish antennas from an antenna array including establishing antenna size, such that a configuration of the antennas established from an antenna array establishes the antenna size.

17. The MIMO communication system of claim 16 comprising:
the circuit configured to randomly select antenna elements being further configured to change the antenna configuration by re-establishing the antennas; and
a circuit for performing an antenna hopping sequence, the antenna hopping sequence extending across plural antenna configurations of the same antenna array.

18. The MIMO communication system of claim 17 wherein said circuit for performing an antenna hopping sequence provides antenna diversity in an azimuth direction while maintaining a substantially constant elevation direction.

19. The MIMO communication system of claim 17 wherein said circuit for performing an antenna hopping sequence provides antenna diversity in both azimuth and elevation directions.

20. The MIMO communication system of claim 17 wherein the circuit for randomly selecting antenna elements maintains a substantially constant antenna size across plural antenna hops in the antenna hopping sequence.

21. An integrated circuit device comprising:
a circuit configured to establish an antenna size for a virtual transmit antenna wherein antenna size is defined as a number of antenna elements making up the virtual transmit antenna; and
a circuit configured to randomly select antenna elements from an antenna array to create the virtual transmit antenna wherein the number of antenna elements selected is equal to the antenna size of the virtual transmit antenna and less than an array antenna size of the antenna array.

22. The integrated circuit device of claim 21 further comprising:
a circuit configured to receive and process feedback information provided from a receiver site; and
a circuit configured to select virtual transmit antennas for which satisfactory feedback information has been received to transmit data to the receiver site.

23. The integrated circuit device of claim 22 wherein the feedback information comprises an antenna identification number.
